(19) United States
(12) Patent Application Publication
(10) Pub. No.: US 2007/0174208 A1
(43) Pub. Date: Jul. 26, 2007

(54) System and Method for Global Automated Address Verification

(75) Inventors: Catherine B. Black, Mesa, AZ (US); Glade R. Erikson, Glendale, AZ (US); Diane Farrell, Phoenix, AZ (US); Chin H. Khor, Glendale, AZ (US); Vernon Marshall, Montclair, NJ (US); Sandeep Sacheti, Edison, NJ (US); Tracy J. Steiner, Phoenix, AZ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/614,691

(22) Filed: Dec. 21, 2006

Related U.S. Application Data
(63) Continuation-in-part of application No. 10/162,282, filed on Jun. 3, 2002.
(60) Provisional application No. 60/295,295, filed on Jun. 1, 2001.

(51) Int. Cl. G06Q 99/00

(52) U.S. Cl. 705/75

(57) ABSTRACT

The present invention provides a system and method for mitigating identity theft risk by restricting shipment of merchandise purchased with instant credit to a verified address. Customer authentication information associated with instant credit is identified. The customer authentication information is verified. Shipment of merchandise purchased with the instant credit is restricted to a verified address to mitigate identity theft risk.

### CROSS REFERENCE TO RELATED APPLICATIONS

This application is a continuation-in-part of United States patent application Ser. No. 10/162,282, entitled “System and Method for Global Automated Address Verification,” filed Jun. 3, 2002, which claims the benefit of U.S. Provisional Patent Application Ser. No. 60/295,295, entitled “Global Automated Address Verification System and Method,” filed Jun. 1, 2001; the entire contents of the '282 and '295 applications are herein incorporated by reference.

### BACKGROUND OF THE INVENTION

1. Field of the Invention

The present invention relates generally to detection of transaction card fraud and, more particularly, to mitigation of identity theft risk by restricting shipment of merchandise purchased with instant credit to a verified address.

2. Background Art

Transaction cards, such as credit cards, charge cards, debit cards, stored value cards, and smart cards, are often used to purchase goods that are shipped from a remote location. Transactions involving remote purchases, particularly those where instant credit is granted, are inherently risky since fraud-minimizing information is not readily available to a merchant. For example, an unauthorized user may complete a remote purchase by presenting only a transaction card number to the merchant. Remote purchases are also often conducted via an electronic medium, such as a telephone or the Internet, where the merchant cannot use conventional techniques for avoiding transaction card fraud.

One method for preventing fraudulent electronic transaction card transactions is to verify a billing address of the customer. In currently available systems providing address verification, purchasers input a billing address (or at least a zip or a postal code) when making a purchase via telephone or the Internet. Transaction card issuers, such as a financial institution, store a billing address and associated customer information. When transaction card information is presented for authorization, the stored billing address is compared with the input billing address. If the stored billing address and the input billing address do not correlate, then the purchaser may be deemed to be an unauthorized user and the transaction may be denied.

Furthermore, the transaction card issuer often provides a payment guarantee to a merchant, so long as purchased goods are shipped only to a billing address. However, if the merchant agrees to ship goods to an address other than the stored billing address, the merchant is responsible if fraud occurs. As a result, many merchants refuse to ship goods to addresses other than the billing address. This discourages not only fraudulent transactions but also valid transactions because it limits cardholder shipping alternatives.

For example, a customer might not be able to use the transaction card via a telephone to purchase a gift for delivery to a non-billing address.

In addition, granting instant credit to a customer in a non-face-to-face environment has identity theft risk as the instant credit can be used before a tangible transaction card is delivered to the customer.

In view of the foregoing, a need exists for a system and method for verifying customer authentication information during authorization of a remote purchase involving instant credit. Moreover, a need exists for a method that reduces transaction card fraud and provides an opportunity for instant credit issuers to guarantee payment to a merchant who ships goods to an address other than a billing address. Additionally, a need exists for a system, a method, and a computer program to mitigate identity theft risk associated with instant credit as well as overcome other problems identified herein.

### BRIEF SUMMARY OF THE INVENTION

The present invention provides a system, a method, and a computer program for mitigating identity theft risk by restricting shipment of merchandise purchased with instant credit to a verified alternate address. An example of a transaction made with instant credit is a purchase where a tangible transaction card is not possessed by a customer. An alternate address is an address other than a billing address such as a shipping address that is known to be authentic.

An exemplary embodiment of the present invention has a merchant system for communicating authentication information with a host authorization system. The authentication information is, for example, an account number and an alternate address. A verification system coupled to the host authorization system provides address verification data to the host authorization system. The verification system and the host authorization system provide verification of a billing address or an alternate address. Shipment of merchandise purchased with instant credit is restricted to a verified address to mitigate identity theft risk. In an example, the transaction card issuer provides a payment guarantee to a merchant based on the verification data.

### BRIEF DESCRIPTION OF THE DRAWINGS/FIGURES

The accompanying drawings, which are incorporated herein and form a part of the specification, illustrate the invention and, together with the description, further serve to explain the principles of the invention and to enable a person skilled in the pertinent art to make and use the invention:

FIG. 1 is a block diagram of an exemplary system for address verification;

FIG. 2 is a flowchart of an exemplary method for address verification;

FIG. 3 is a flowchart of an exemplary method for mitigating identity theft risk;

FIG. 4 is a flowchart of another exemplary method for mitigating identity theft risk; and

FIG. 5 is a block diagram of an exemplary computer system that is useful for implementing the present invention.

The invention will be described with reference to the accompanying drawings.

The drawing in which an element first appears is typically indicated by the leftmost digit(s) in the corresponding reference number.

### DETAILED DESCRIPTION OF THE INVENTION

The following disclosure presents and describes various exemplary embodiments in sufficient detail to enable those skilled in the art to practice the invention. It should be understood that other embodiments may be realized without departing from the spirit and scope of the invention. Thus, the following detailed description is presented for purposes of illustration only, and not of limitation, and the scope of the invention is defined solely by the claims.

A system, method, and computer program in accordance with various aspects of the present invention verifies customer authentication information such as a billing address or an alternate address for transaction card account purchases. A system, method, and computer program in accordance with various aspects of the present invention mitigates identity theft risk by restricting shipment of merchandise purchased with instant credit to a verified address.

An exemplary embodiment of the present invention has a merchant system for communicating authentication information with a host authorization system. The merchant system and the host authorization system communicate authentication information including customer information such as an account number and an alternate address. An alternate address is an address other than a billing address, such as a shipping address. A verification system coupled to the host authorization system provides address verification data to the host authorization system. Address verification data is based on the account number and the alternate address. The verification system and the host authorization system provide verification of authentication information such as a billing address or an alternate address. Shipment of merchandise purchased with instant credit is restricted to a verified address to mitigate identity theft risk. In examples, the transaction card issuer provides a payment guarantee to a merchant based on the verification data.

In an exemplary embodiment, a merchant receives authentication information such as a customer billing address, an alternate address, or the like. The merchant forwards the authentication information to a host authorization system, which verifies at least part of the authentication information. The host authorization system sends authentication information to a verification system. The verification system verifies the authentication information by comparing the provided authentication information with stored information that is known to be authentic. The information known to be authentic is stored in a database. After comparing, the verification system transmits results of the comparison to the host authorization system. If the authentication information matches stored information, the authentication information provided is deemed verified and merchandise is shipped to an address that is known to be authentic. In examples, the transaction card issuer may additionally offer a payment guarantee to the merchant. If the authentication information does not match stored information known to be authentic, the merchandise is not shipped. Further, if the authentication information does not match stored information known to be authentic, the card issuer may choose not to offer a payment guarantee to the merchant. However, the merchant may authorize the purchase and ship the purchased item to the alternate address.

The present invention is described herein in terms of functional block components and various processing steps. It should be appreciated that such functional blocks may be realized by any number of hardware or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. The examples described herein are illustrative of the invention and are not intended to otherwise limit the scope of the present invention in any way.

Communication between participants in the system of the present invention is accomplished through any suitable communication channel, such as, for example, a telephone network, a public switched telephone network, an intranet, an Internet, an extranet, a WAN, a LAN, a point of interaction device (e.g., a point of sale device, a personal digital assistant, a cellular phone, a kiosk terminal, an automated teller machine (ATM), or the like), a wireless communications device, a satellite, or the like.

Each participant or user of the system of the present invention, including purchasers, merchants, card issuers, and third-party verifiers, for example, may be equipped with a suitable computing system to facilitate communications and transactions with any other participant. For example, some or all participants may have access to a computing unit in the form of a personal computer, although other types of computing units may be used, including laptops, notebooks, handheld computers, set-top boxes, kiosk terminals, personal digital assistants, cellular phones, and the like. Additionally, other participants may have computing systems which may be implemented in the form of a computer server, PC server, workstation, minicomputer, mainframe, a networked set of computers, or any other suitable implementations which are known in the art or may hereafter be devised. Moreover, the system contemplates the use, sale, or distribution of any goods, services, or information over any network having functionality similar to that described herein.

The computing systems are connected with each other via a data communications network, as described herein. In an example, the data communication network is a public network, such as the Internet. In this context, the computers may or may not be connected to the Internet at all times. The merchant's computer system may also be interconnected to a card issuer via a second network, referred to as a payment network. Examples of a payment network include the American Express®, VisaNet®, and Veriphone® networks.

As will be appreciated, the present invention may be embodied as a method, a data processing system, a device for data processing, or a computer program product. Accordingly, aspects of the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including a hard disk, a CD-ROM, an optical storage device, a magnetic storage device, or the like.

The present invention is described below with reference to at least one block diagram and at least one flowchart of a method, an apparatus (e.g., system), and a computer program product according to various aspects of the invention. Each functional block and combinations of functional blocks in the block diagram and flowchart illustration, respectively, can be implemented by computer program instructions. These computer program instructions can be loaded onto a computer or other programmable data processing apparatus to produce a machine that creates means for implementing the functions specified in the flowchart block or blocks.

Computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose, hardware-based computer systems which perform the specified functions or steps, or suitable combinations of special purpose hardware and computer instructions.

The terms “user” and “participant” interchangeably include any person, entity, machine, hardware, software, or business who accesses and uses the system of the invention, including purchasers, merchants, card issuers, and verification systems. Participants in the system may interact with one another. It is further noted that other participants may be involved in various embodiments of the invention, such as an intermediary settlement institution, though these participants are not always described in detail.

The term “online” may include interactive communications that take place between participants who are remotely located from one another, including communication through any of the networks or communications means described herein or the like.

The term “merchant” may include any person, entity, machine, software, hardware, or the like that offers a product or service to a purchaser. A merchant may offer, sell, lease, or otherwise provide a product or a service to a purchaser.

The terms “purchaser,” “customer,” “consumer,” “cardmember,” and “card-holder” are used interchangeably, and each may include any person, entity, business, or the like which engages in a commercial transaction with a merchant in accordance with various embodiments of the system. A purchaser or customer may be an authorized or an unauthorized user of a transaction account.

The terms “user,” “end user,” “consumer,” “customer,” “participant,” and the plural form of these terms are used interchangeably throughout herein to refer to those persons or entities capable of accessing, using, being affected by or benefiting from the present invention.

A “verification system” may include any person, entity, machine, hardware, software, business, or the like which is capable of verifying at least one of a billing address, an alternate address, and customer authentication information offered to a merchant. In examples, a verified address is an address of known authenticity that is associated with the transaction account. In examples, a verified address is an address of known authenticity that is associated with instant credit.

The scope of verification may vary. For example, verification may include verifying at least a portion of the alternate address, the billing address, or other information associated with the customer. Verification may be during the transaction, close in time, or at a time other than during the transaction, simultaneous with another process, or the like.

A “transaction card issuer,” “card issuer,” or “host” may be used interchangeably to represent any transaction card issuing institution, such as, but not limited to, a credit card company, a card-sponsoring company, or a third party who is under contract with a financial institution. A “transaction card issuer”, “card issuer”, or “host” may be used interchangeably to represent any institution that provides instant credit, such as, but not limited to, a credit card company, a card-sponsoring company, or a third party who is under contract with a financial institution.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument. A transaction account results from the issuance of instant credit. A transaction account may exist without issuance of a transaction card.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer.

With regard to use of a transaction account, users may communicate with merchants in person (e.g., at the box office), telephonically, or electronically (e.g., from a user computer via the Internet). During the interaction, the merchant may offer goods or services to the user. The merchant may also offer the user the option of paying for the goods or services using any number of available transaction accounts. Furthermore, the transaction accounts may be used by the merchant as a form of identification of the user. The merchant may have a computing unit, for example, a merchant system, implemented in the form of a computer-server, although other implementations are possible.

In general, transaction accounts may be used for transactions between the user and merchant through any suitable communication means, such as, for example, a telephone network, an intranet, an Internet, a point of interaction device (e.g., a point of sale (POS) device, a personal digital assistant (PDA), a mobile telephone, a kiosk, etc.), or the like.

An “account,” “account number,” or “account code,” as used herein, may include any device, code, number, letter, symbol, digital certificate, smart chip, biometric or other identifier suitably configured to allow a consumer to access, interact with or communicate with a financial transaction system. The account number may optionally be located on or associated with any financial transaction instrument (e.g., reward card, charge card, credit card, debit card, prepaid card, telephone card, embossed card, smart card). The account number may optionally be located on, or associated with, a magnetic stripe, a bar code, a transponder or a radio frequency card.

The account number may be distributed and stored in any form of plastic, electronic, magnetic, radio frequency (RF), radio frequency identification (RFID), wireless, audio or optical device capable of transmitting or downloading data to a second device. A customer account number may be, for example, a sixteen-digit credit card number, such as the fifteen-digit numbering system used by American Express Company of New York, N.Y. Each issuer's credit card numbers comply with the standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder, or cardmember.

A merchant account number is, for example, any number or alpha-numeric character that identifies a particular merchant. In examples, a merchant account number is used for purposes of card acceptance, account reconciliation, reporting and the like.

The term “billing address” includes an address that is associated with a customer and is recognized as designating the location where a customer receives correspondence relating to a customer account (e.g., associated with instant credit). For example, the billing address is the address to which a card issuer sends correspondence to a customer regarding transaction activity on the customer's account (e.g., first and last name, address, country, phone number, or the like).

An “alternate address” includes an address other than the billing address. For example, the alternate address may be where a customer desires a merchant to send a purchased item, such as a shipping address. In examples, the alternate address is identical to the billing address. The alternate address may be associated with a recipient who is not the customer and may be, therefore, different than the billing address.

A “payment guarantee” may include a no charge-back guarantee to a merchant for fraud. A “payment guarantee” may include any other guarantee or agreement offered by card issuers to merchants, purchasers, users, or the like associated with a transaction.

In examples, a system and method are provided to verify the alternate address and the billing address of a customer. It will be understood that the present invention may be applied outside the context of a customer making a transaction, but is illustrated as such for brevity.

In an exemplary embodiment, the merchant obtains authentication information from the customer who wishes to purchase merchandise for delivery to a recipient. The recipient and alternate address information is validated by a verification system. If the customer and the recipient or the alternate address information provided by the purchaser do not correspond to authentic stored information, the card issuer declines shipment of the merchandise. Authentication information associated with instant credit may include the name of the recipient of the purchased item, the recipient's alternate address (i.e., the shipping address), the recipient's phone number, the service establishment number, the customer's name, the card number, the customer's billing address, the customer's phone number, known information (e.g., PIN number, address), identifying information (e.g., biometrics, photograph, and the like), information possessed (e.g., card), or the like. In one exemplary embodiment, customer authentication information is validated by the card issuer, (e.g., the card issuer authorizes the customer to use instant credit (e.g., credit authorization)).

By verifying an alternate address, the present invention enhances the ability of a card issuer to offer a payment guarantee to a merchant for a purchase made with instant credit, even if the purchased merchandise is shipped to an address other than a billing address. Accordingly, the present invention facilitates verification of the billing and alternate addresses. The system and method described are associated with an instant credit purchase; however, the present invention may be used with any other transaction (e.g., bank card transactions, any commercial transaction, any area of commerce, or the like).

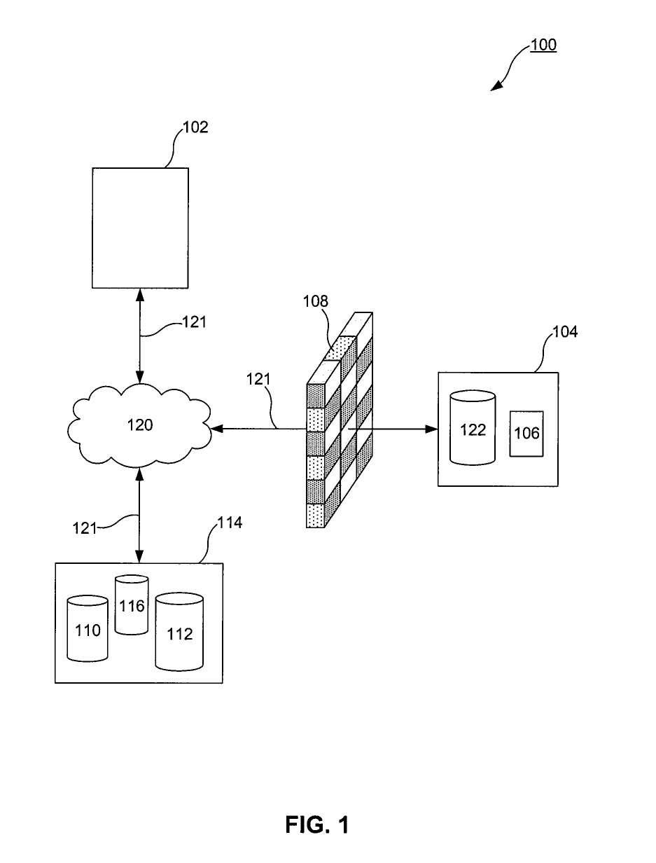

FIG. 1 is a block diagram of a system 100 for mitigating identity theft risk and address verification in accordance with an exemplary embodiment of the present invention. System 100 includes a merchant system 102, a host authorization system 104, and a verification system 114. A merchant system 102, host authorization system 104, and verification system 114 are configured to communicate through a network 120. Merchant system 102 submits data to host authorization system 104. Merchant system 102 and host authorization system 104 communicate via a communication channel 121.

Communication channel 121 may be a part of network 120. Customer authentication information submitted to host authorization system 104 includes information associated with a customer. Verification system 114 is coupled to host authorization system 104 via communication channel 121 and retrieves data from host authorization system 104 associated with the verification of an alternate address of the customer. System 100 verifies at least one of the customer authentication information, the alternate address, the billing address, and other information. System 100 may verify the alternate address and the billing address substantially simultaneously. In examples, the transaction card issuer provides a payment guarantee for payment to the merchant based on the verification of at least one of the customer authentication information, the alternate address, the billing address, and other information.

Network 120 is any hardware or software system for enabling communication between merchant system 102, host authorization system 104, and verification system 114. For example, network 120 may include any communications system that enables the transmission or exchange of data. Exemplary networks include the Internet, an intranet, an extranet, a wide area network (WAN), a local area network (LAN), a satellite, or the like. In an exemplary embodiment, merchant system 102, host authorization system 104, and verification system 114 are coupled to network 120 by means suitable for connecting a computing system to a network.

Merchant system 102 includes hardware or software configured to store information and interact with the other components of system 100. In an example, customer authentication information is entered into merchant system 102. Although only one merchant system 102 is illustrated in FIG. 1, it will be appreciated that system 100 may include any number of merchant systems 102 in communication with host authorization system 104 or verification system 114 through network 120. In an exemplary embodiment, host authorization system 104 and verification system 114 are separate systems, which may be located in one location or remotely located from one another. In an example, verification system 114 is integrated within host authorization system 104 such that an integrated verification system and host authorization system are components of a single computing device (e.g., separate modules of a single computing unit). In an example, verification system 114 and host authorization system 104 are separate components of an integrated computing system, wherein authorization and verification components of the computing system communicate with each other via a network.

In an example, host authorization system 104 is configured to store information, process information and interact with the other components of system 100. In one embodiment, host authorization system 104 receives customer authentication information provided by merchant system 102 regarding a card purchase transaction. Host authorization system 104 processes the customer authentication information and transmits a request to verification system 114. Host authorization system 104 receives verification information from verification system 114 in response to the transmitted request. Host authorization system 104 processes verification information from verification system 114 to determine whether to permit shipment of merchandise. In examples, host authorization system 104 communicates a payment guarantee to the merchant if the customer authentication information is verified.

In an exemplary embodiment, host authorization system 104 includes a host database 122 and a timing mechanism 106. In one embodiment, host authorization system 104 performs various authentication processes, such as billing address verification, verification of customer information, and credit verification. Host database 122 is configured to store customer data, transactional data, and any other data related to the use of a transaction card by a customer. Timing mechanism 106 records time.

In another exemplary embodiment, host authorization system 104 transmits information to verification system 114 through gateway 108. Gateway 108 may include any hardware or software for enhancing security of communications between two systems.

In accordance with an exemplary embodiment of the present invention, a verification system 114 includes recipient database 110 and association database 112. In examples, verification system 114 includes hardware and software configured to store information, process information and interact with other components of system 100. Verification system 114 may include a transaction history database 116, which stores information relating to a customer and a customer's purchases that were made using a transaction card. Although illustrated in FIG. 1 as part of verification system 114, transaction history database 116 may alternatively be a part of merchant system 102, host authorization system 104, or separate.

In examples, transaction history database 116, databases 110, 112, 122, and other data storage devices referred to herein include any type of hardware and software device which is configured to store and maintain customer transaction data and any other suitable information.

Verification system 114 processes and responds to requests from host authorization system 104 for verification information regarding a designated recipient for merchandise purchased by a customer from a merchant. In an example, the verification information includes at least one of a recipient's name, a recipient's address, a recipient's phone number, a service establishment number, a merchant account number, a card number presented to purchase the item, a customer's name, a customer's billing address, an alternate address, a customer's phone number, and the like. In examples, verification information is reliable information about a person or legal entity stored prior to a request for instant credit. By storing and processing such verification information, verification system 114 facilitates a determination by host authorization system 104 regarding whether to authorize shipment of merchandise to an address other than a billing address.

In an exemplary embodiment, verification system 114 may be operated by a third party verification system, such as Acxiom Corporation of Little Rock, Ark.

In various embodiments, verification system 114 may have one or more databases, such as recipient index database 110 and association database 112. Recipient index database 110 and association database 112 have authentic information, such as address information, customer identity information, or the like. In one exemplary embodiment, recipient index database 110 and association database 112 have information compiled by a party other than an issuer of instant credit.

The system of the invention, as well as any of its component systems, may include a host server or other computing system, including a processor for processing digital data, a memory coupled to the processor for storing digital data, an input digitizer coupled to the processor for inputting digital data, an application program stored in the memory and accessible by the processor for directing the processing of digital data by the processor, a display coupled to the processor and memory for displaying information derived from digital data processed by the processor and a plurality of databases, the databases including client data, merchant data, financial institution data or like data that could be used in association with the present invention.

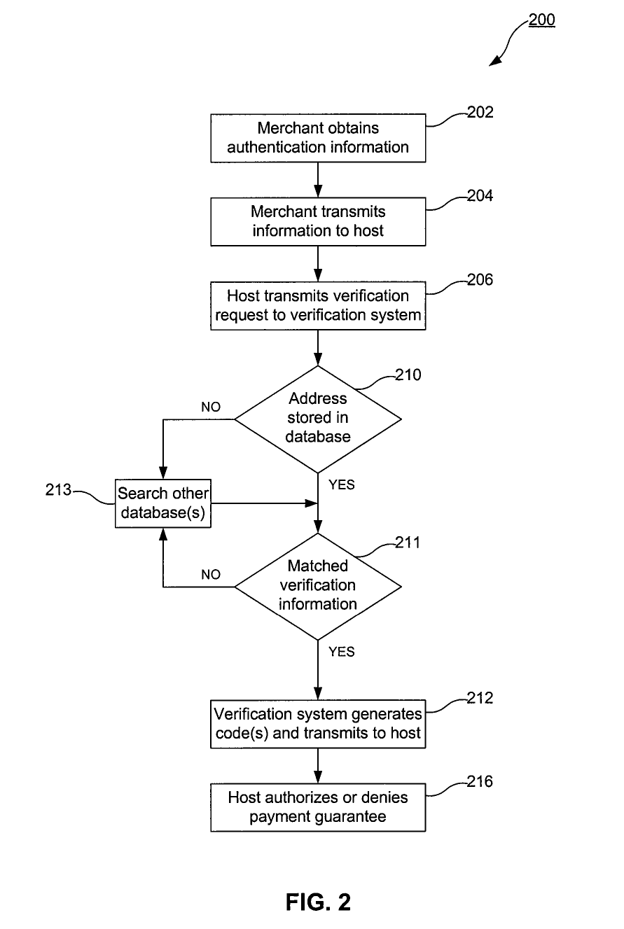

FIG. 2 is a flowchart of a method for address verification 200 in accordance with an exemplary embodiment of the present invention. Although FIG. 2 illustrates a series of method steps, it will be realized that the order of particular steps may be altered and other steps may be omitted altogether while still attaining the same or a similar result. In accordance with an exemplary embodiment of the present invention, a merchant may obtain authentication information from a prospective transaction card purchaser (step 202). The authentication information may be obtained over the phone, via fax, via an online network (such as the Internet, for example), in-person, or by other means. Merchant system 102 may then be used to transmit this information to host authorization system 104 through network 120 (step 204).

Host authorization system 104 sends at least part of the authorization information to verification system 114 (step 206). Host authorization system 104 may transmit the subset of the authorization information to verification system 114 through gateway 108.

The subset of information transmitted to verification system 114 may include, for example, card number, recipient's name, recipient's address, recipient's phone number, and the service establishment number. This subset of information (i.e., “verification information”) is transmitted to verification system 114 as a “verification request.”

In accordance with one aspect of the present invention, when verification system 114 receives a verification request, it converts the verification information into a code which may include unique tags (i.e., identifiers) that can be stored and searched. Each component of the verification information may be converted into its own unique tag. For example, one unique tag, referred to as an “index”, may identify the alternate address, name, or other information associated with a recipient, user, or consumer. When recipient names, addresses, or the like are described herein as being stored or searched, unique tags may be used to associate the various aspects of the verification information stored or searched.

Verification system 114 queries transaction history database 116 to determine whether the address identified by the purchaser as a recipient's address is stored therein (step 210). For example, verification system 114 attempts to verify the alternate address of a customer by comparing the alternate address to information stored in one or more databases. If the recipient's address is not stored in transaction history database 116, then verification system 114 generates a code to that effect and transmits the code to host authorization system 104 via gateway 108. Optionally, if the recipient's address is not stored in transaction history database 116, then various other databases may be searched to facilitate determining the address identified by the purchaser as a recipient's address (step 213).

If the recipient address provided during a current card transaction is stored in transaction history database 116, analysis of the verification information continues. Verification system 114 searches transaction history database 116 to determine if the current verification information provided for the current card transaction matches prior verification information that was provided in a prior transaction with the same card number within a predetermined or selected time frame (step 211).

The predetermined time frame before the current transaction may be of any length. For example, the predetermined time frame corresponds to a period of time in which it would be likely that an unauthorized user of the card number would be in the process of making multiple unauthorized card transactions. Exemplary time frames may include the previous 24 hours, the previous 48 hours, the previous 72 hours, the last week, or the like. Transaction history database 116 stores verification information obtained from customers for a predetermined storage period (e.g., about 24 hours, about 48 hours, about 72 hours, or the like). This predetermined storage period enables the comparison of verification information associated with various card transactions involving the same card number over the predetermined time frame. Moreover, the use of a predetermined storage period also permits limitations on the volume of information stored and maintained by verification system 114, so that maintenance of the database does not become overly burdensome and the process of verification is simplified. The predetermined time frame and the predetermined storage period may be selected independently of one another. Alternatively, the predetermined time frame and the predetermined storage time may coincide.

Verification system 114 continues analyzing verification information by searching index database 110 to determine if the recipient index created by verification system 114 matches an index stored in index database 110. If no match exists, an appropriate code (e.g., one or more fields of information) is generated and transmitted to host authorization system 104 (step 212). Such a code may include at least one selected character or digit, such as an “X” or a “9” to represent various information. Various fields of information optionally include “a” for customer name and billing address match, “k” for no match of information, “1” billing address match only, “p” payment guarantee, “x” system not responding, and the like. The codes or fields are optional.

If there is a match between the recipient index and an index in index database 110, then verification system 114 searches its association database 112 to determine if the recipient phone number and recipient address provided for the current transaction are associated (step 212). If so, this increases the probability that the recipient address is legitimate, and an appropriate code is transmitted to host authorization system 104 indicating that the recipient's phone number and address are associated. Verification system 114 also searches association database 112 to determine if the recipient address is a business. If so, an appropriate code is transmitted to host authorization system 104 indicating that the recipient's address is a business. Additionally, verification system 114 searches association database 112 to determine whether the current recipient's name and address match a name and address stored in association database 112. If so, the analysis continues. If not, an appropriate code is transmitted to host authorization system 104 indicating that there is no name and address match. Verification system 114 uses index database 110 to determine if the recipient name is associated with the recipient address. If so, this increases the probability that the address is legitimate, and an appropriate code is transmitted to host authorization system 104 indicating the association of the recipient's name and address. If not, then an appropriate code is returned indicating that there is no match.

If verification information provided by a customer matches verification information provided for a purchase made within the predetermined time frame, the verification system 114 transmits the same code that was originally generated for the most recent prior card transaction to host authorization system 104 (step 212). In this manner, verification system 114 identifies the card number being used in a current transaction as having been used to purchase and deliver an item to the same alternate address within the recent past. The host authorization system 104 receives and processes this code to determine whether the card issuer will authorize a payment guarantee to the merchant for the sale of an item shipped to the designated recipient. Use of the same code for a current purchase that was generated for the most recent matching card number transaction efficiently indicates to the card issuer that the card has been used previously as a means for obtaining and sending purchases to an alternate address. Use of the same code for a current purchase indicates further analysis of verification information by verification system 114 is not required.

If current verification information provided by a customer does not match any prior verification information stored in transaction history database 116, various other databases may be searched for a predetermined time period, in order to verify the recipient's address (step 213). Verification system 114 sends tagged and coded current verification information to transaction history database 116 for storage. For example, the verification information is stored in transaction history database 116 for the predetermined storage period and is compared with future transactions to determine whether a verification information match exists. In examples, a code generated during subsequent process steps using current verification information are transmitted to transaction history database 116 to be associated with the stored verification information.

In an example, host authorization system 104 uses any or all of the transmitted codes to determine whether to offer a payment guarantee to a merchant for the current card transaction (step 216). Step 216 is optional. In examples, host authorization system 104 uses any or all of the transmitted codes to determine whether to authorize shipment of merchandise for the current transaction. In examples, host authorization system 104 receives and processes the code and then determines whether to authorize or deny a payment guarantee to the merchant. For example, host authorization system 104 may provide a payment guarantee if the alternate address is verified. Alternatively, host authorization system 104 may provide a payment guarantee if the billing address and the alternate address are verified in one transaction. Host authorization system 104 may inform merchant system 102 of whether a payment guarantee will be granted, and the merchant may authorize or deny a purchase transaction with a customer based upon whether the payment guarantee is granted. Information related to authorized or denied transactions may optionally be stored in transaction history database 116.

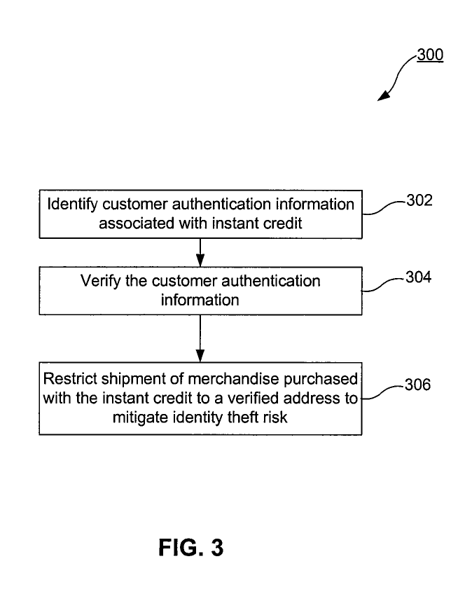

FIG. 3 is a flowchart of a method for mitigating identity theft risk 300. In step 302, customer authentication information associated with instant credit is identified. The customer authentication information is received by host authorization system 104. In examples, the customer authentication information is received by verification system 114. The customer authentication information includes at least one of a customer name, a billing address, an application address, a customer phone number, an account number, a recipient's name, an alternate address, a recipient's phone number, and a service establishment number. Instant credit may also be issued to a customer. In an example, instant credit is issued substantially contemporaneously with identifying customer authentication information. A recipient is a person to whom merchandise is shipped.

In step 304, the customer authentication information is verified. Verification is performed at least in part by a verification system 114 or host authorization system 104. Verification includes comparing the customer authorization information to stored information. Stored information is information that is known to be accurate by the transaction card issuer. Stored information may be stored in the recipient index database 110 or the host database 122. Verification may also include determining if the customer authorization information matches the stored information. A transaction authorization result may be based at least in part upon the verification. The transaction result may be communicated to the merchant system 102. In examples, verifying customer authentication information 304 includes executing the method for address verification 200.

In step 306, shipment of merchandise purchased with the instant credit is restricted to a verified address to mitigate identity theft risk. A verified address may include at least one of a billing address, an alternate address, an application address, and a ship-to address. An application address is an address provided in association with an application for credit, such as an application for instant credit. A ship-to address is an address to which merchandise is to be shipped.

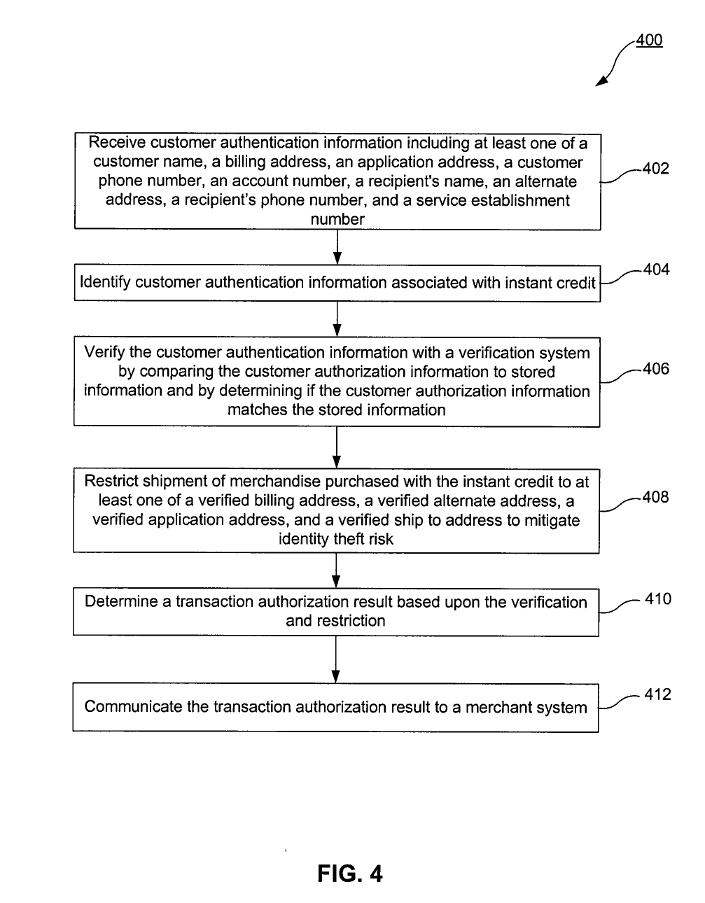

FIG. 4 is a flowchart of an exemplary method for mitigating identity theft risk 400 in accordance with an exemplary embodiment of the present invention.

In step 402, customer authentication information including at least one of a customer name, a billing address, an application address, a customer phone number, an account number, a recipient's name, an alternate address, a recipient's phone number, and a service establishment number is received. In examples, the customer authentication information is received by a host authorization system. In examples, the customer authentication information is received from a merchant system.

In step 404, customer authentication information associated with instant credit is identified.

In step 406, the customer authentication information is verified with a verification system by comparing the customer authentication information to stored information and determining if the customer authentication information matches the stored information. In an example, verifying customer authentication information 304 includes executing the method for address verification 200.

In step 408, shipment of merchandise purchased with the instant credit is restricted to at least one of a verified billing address, a verified alternate address, a verified application address, and a verified ship-to address to mitigate identity theft risk.

In step 410, a transaction authorization result is determined based upon the verifying and the restricting.

In step 412, the transaction authorization result is communicated to the merchant system.

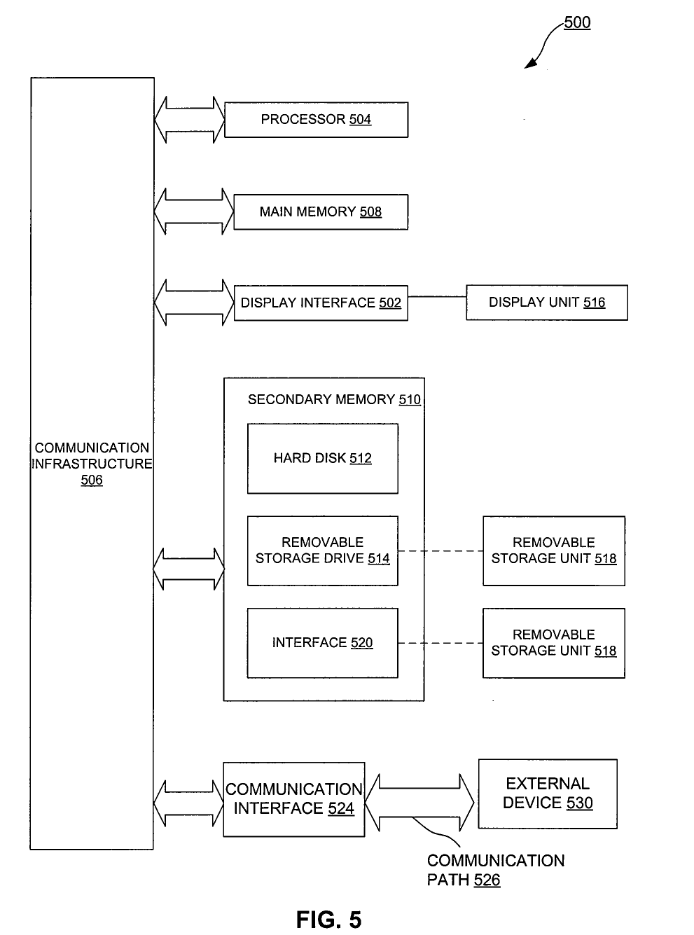

FIG. 5 is a block diagram of a computer system 500 that is useful for implementing the present invention in accordance with an exemplary embodiment of the present invention. The methods and processes herein (i.e., the system and process listed above or any part(s) or function(s) thereof) may be implemented using hardware, software, or a combination thereof. The methods and processes herein may be implemented in one or more computer systems or other processing systems. The manipulations performed by the present invention are often referred to in terms which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices. In examples, host authorization system 104, merchant system 102, verification system 114, and network 120 have, or are part of, at least one computer system 500. In examples, computer system 500 performs at least part of method for mitigating identity theft risk 300 and part of method for mitigating identity theft risk 400.

Computer system 500 includes a processor 504. Processor 504 is connected to a communication infrastructure 506 (e.g., a communications bus, cross-over bar, or network). Various software embodiments are described in terms of this exemplary computer system.

Computer system 500 can include a display interface 502 that forwards graphics, text, and other data from communication infrastructure 506 (or from a frame buffer not shown) for display on display unit 516.

Computer system 500 also includes a main memory 508, preferably random access memory (RAM), and may also include a secondary memory 510. Secondary memory 510 may include, for example, a hard disk drive 512 or a removable storage drive 514, representing a floppy disk drive, a magnetic tape drive, an optical disk drive, an information storage device, etc. Removable storage drive 514 reads from and writes to a removable storage unit 518. Removable storage unit 518 represents a floppy disk, a magnetic tape, an optical disk, etc. which is read by, and written to, by removable storage drive 514. Removable storage unit 518 includes a computer usable storage medium having information such as a computer program or data stored therein.

In alternative embodiments, secondary memory 510 may include other similar devices for allowing computer programs or other instructions to be loaded into computer system 500. Such devices may include, for example, removable storage unit 518 and an interface 520. Examples of secondary memory 510 include a program cartridge and cartridge interface, a removable memory chip (such as an erasable programmable read only memory (EPROM), and programmable read only memory (PROM)) with an associated socket, and removable storage unit 518 or interface 520, which allow software and data to be transferred from removable storage unit 518 to computer system 500.

Computer system 500 may also include a communications interface 524. Communications interface 524 allows software and data to be transferred between computer system 500 and an external device 530. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals which may be electronic, electromagnetic, optical or other signals capable of being received by communications interface 524. These signals are provided to communications interface 524 via a communications path (e.g., channel) 526. Communications path 526 carries signals and may be implemented using a wire, fiber optics, a telephone line, a cellular link, a radio frequency (RF) link, or other communications channels.

In this document, the terms “computer program medium” and “computer usable medium” are used to generally refer to media such as removable storage drive 514 or a hard disk installed in hard disk drive 512. Computer program products such as a computer program medium and a computer usable medium provide instructions to computer system 500. The invention is directed in part to such computer program products.

Computer programs (also referred to as computer control logic) are stored in main memory 508 or secondary memory 510. Computer programs may also be received via communications interface 524. Such computer programs, when executed, enable computer system 500 to perform the features of the present invention, as discussed herein. In particular, the computer programs, when executed, enable processor 504 to perform the features of the present invention. Accordingly, such computer programs represent controllers of computer system 500.

In an embodiment where the invention is implemented using software, the software may be stored in a computer program product and loaded into computer system 500 using removable storage drive 514, hard drive 512, or communications interface 524. The control logic (software), when executed by processor 504, causes processor 504 to perform the functions of the invention as described herein.

In another embodiment, the invention is implemented as a hardware state machine using hardware components such as an application specific integrated circuit (ASIC). Implementation of the hardware state machine so as to perform the functions described herein will be apparent to persons skilled in the relevant art(s). In an example, the invention is implemented using a combination of both hardware and software.

The invention has been described with reference to exemplary embodiments.

Various modifications and changes can be made without departing from the scope of the present invention as set forth in the claims. The specification and figures are to be regarded in an illustrative manner, rather than a restrictive one, and all modifications are intended to be included within the scope of present invention. Accordingly, the scope of the invention should be determined by the appended claims and their legal equivalents, rather than limited by the examples given above. For example, the steps recited in any of the method or process claims may be executed in any order and are not limited to the order presented in the claims. The Abstract and Summary sections are not intended to limit the scope of the present invention in any way.

What is claimed is:

1. A method for mitigating identity theft risk, comprising:
identifying customer authentication information associated with instant credit;
verifying the customer authentication information; and
restricting shipment of merchandise purchased with said instant credit to a verified address to mitigate identity theft risk.

2. The method of claim 1, further including receiving said customer authentication information.

3. The method of claim 1, wherein said customer authentication information includes at least one of a customer name, a billing address, an application address, a customer phone number, an account number, a recipient's name, an alternate address, a recipient's phone number, and a service establishment number.

4. The method of claim 1, further comprising issuing said instant credit to a customer.

5. The method of claim 4, wherein said instant credit is provided in association with an online purchase.

6. The method of claim 1, wherein said verifying further includes comparing said customer authentication information to stored information.

7. The method of claim 6, wherein said verifying further includes determining if said customer authentication information matches said stored information.

8. The method of claim 1, further comprising determining a transaction authorization result based upon said verifying.

9. The method of claim 8, further comprising communicating said transaction authorization result to a merchant system.

10. The method of claim 1, wherein said verified address is at least one of a billing address, an alternate address, an application address, and a ship-to address.

11. A method for mitigating identity theft risk, comprising:
receiving customer authentication information including at least one of:
a customer name,
a billing address,
an application address,
a customer phone number,
an account number,
a recipient's name,
an alternate address,
a recipient's phone number, and
a service establishment number;
identifying customer authentication information associated with instant credit;
verifying the customer authentication information with a verification system, wherein said verifying further includes:
comparing said customer authentication information to stored information and
determining if said customer authentication information matches said stored information;
restricting shipment of merchandise purchased with said instant credit to at least one of a verified billing address, a verified alternate address, a verified application address, and a verified ship-to address to mitigate identity theft risk;
determining a transaction authorization result based upon said verifying and said restricting; and
communicating said transaction authorization result to a merchant system.

12. A computer program product comprising a computer useable medium having control logic stored therein for causing a computer to mitigate identify theft risk, the control logic comprising:
first computer readable program code means for causing the computer to identify customer authentication information associated with instant credit;
second computer readable program code means for causing the computer to verify the customer authentication information; and
third computer readable program code means for causing the computer to restrict shipment of merchandise purchased with said instant credit to a verified address to mitigate identity theft risk.

13. The computer program product of claim 12, the control logic further comprising a fourth computer readable program code means for causing the computer to receive said customer authentication information.

14. The computer program product of claim 12, wherein said customer authentication information includes at least one of a customer name, a billing address, an application address, a customer phone number, an account number, a recipient's name, an alternate address, a recipient's phone number, and a service establishment number.

15. The computer program product of claim 12, the control logic further comprising a fourth computer readable program code means for causing the computer to issue said instant credit to a customer.

16. The computer program product of claim 15, wherein said instant credit is provided in association with an online purchase.

17. The computer program product of claim 12, wherein said second computer readable program code is executed at least in part by a verification system.

18. The computer program product of claim 12, wherein said second computer readable program code further includes means for causing the computer to compare said customer authentication information to stored information.

19. The computer program product of claim 18, wherein said second computer readable program code further includes means for causing the computer to determine if said customer authentication information matches said stored information.

20. The computer program product of claim 12, the control logic further comprising a fourth computer readable program code means for causing the computer to determine a transaction authorization result based upon said customer authentication information verification.

21. The computer program product of claim 20, the control logic further comprising a fourth computer readable program code means for causing the computer to communicate said transaction authorization result to a merchant system.

22. The computer program product of claim 12, wherein said verified address is at least one of a billing address, an alternate address, an application address, and a ship-to address.

23. A computer program product comprising a computer useable medium having control logic stored therein for causing a computer to mitigate identify theft risk, the control logic comprising:
first computer readable program code means for causing the computer to receive customer authentication information including at least one of:
a customer name,
a billing address,
an application address,
a customer phone number,
an account number,
a recipient's name,
an alternate address,
a recipient's phone number, and
a service establishment number;
second computer readable program code means for causing the computer to identify customer authentication information associated with instant credit;
third computer readable program code means for causing the computer to verify the customer authentication information with a verification system, wherein said third computer readable program code further includes means for causing the computer to:
compare said customer authentication information to stored information and
determine if said customer authentication information matches said stored information;
fourth computer readable program code means for causing the computer to restrict shipment of merchandise purchased with said instant credit to at least one of a verified billing address, a verified alternate address, a verified application address, and a verified ship-to address to mitigate identity theft risk;
fifth computer readable program code means for causing the computer to determine a transaction authorization result based upon said verifying and said restricting; and
sixth computer readable program code means for causing the computer to communicate said transaction authorization result to a merchant system.
